(19) United States
(12) Patent Application Publication
(10) Pub. No.: US 2004/0250204 A1
(43) Pub. Date: Dec. 9, 2004

(54) Web site development software

(76) Inventor: Cory Isaacson, Woodland Hills, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 10/844,095

(22) Filed: May 11, 2004

Related U.S. Application Data
(60) Provisional application No. 60/470,315, filed on May 14, 2003.

(51) Int. Cl. G06F 17/00

(52) U.S. Cl. 715/517; 715/513; 715/501.1

(57) ABSTRACT

A computer-readable medium included in a computer containing a web site development software program. The program includes an application pattern and a tag library. The application pattern has a view pattern. The application pattern includes style elements, presentation elements, and navigation logic elements. The view pattern incorporates the style elements and presentation elements of the application pattern. The tag library is configured to allow rendering of graphic user interface components.

### CROSS-REFERENCE TO RELATED APPLICATION

Priority is claimed under 35 U.S.C. § 119(e) to U.S. Provisional Patent Application No. 60/470,315, filed on May 14, 2003, entitled “Web Site Development Software” by Cory Isaacson, which application is incorporated by reference herein.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

1. Field of the Invention

The invention relates generally to the field of computer software. More specifically, the invention relates to computer software used for Web application development.

2. Description of Related Art

The development of Internet and Intranet Web applications can be a time-consuming process. The Web site developer, in addition to understanding the requirements for each Web application, must be able to use hyper text markup language (“HTML”) and other software packages and formats. In addition, many Web site development software approaches require the developer to include redundant code for identical presentation logic processing, image placement, graphical design, and user interface controls repeated on different pages of the same Web site or application. In addition, advanced graphical user interface (“GUI”) features are difficult and time consuming to program, and are often lacking when compared to other graphical application environments. Accordingly, there is a need for a Web site development software package that eliminates the need for such redundant components, while providing a consistent and powerful GUI for an entire Web application. The present invention satisfies these needs.

### SUMMARY OF THE INVENTION

Embodiments of the present invention are included in a Web application development software package that provides a standardized architecture for supporting advanced, standardized GUI capabilities and presentation logic across an application, and which shortens development time by reducing the amount of redundant coding. Embodiments of the present invention include a computer-readable medium included in a computer and containing a web site development software program. The program includes an application pattern and a tag library. The application pattern has a view pattern, wherein the application pattern includes style elements, presentation elements, and navigation logic elements, and the view pattern incorporates the style elements and presentation elements of the application pattern. The tag library is configured to allow rendering of graphic user interface components.

In other, more detailed features of the invention, the view pattern includes a frame page having visual components and non-visual components. The visual components include a toolbar developed using a technique selected from the group consisting of scalable vector graphics and dynamically positioning graphic image components. The toolbar includes toolbar buttons and each of the toolbar buttons has a state selected from the group consisting of enabled, disabled, and hidden.

In other, more detailed features of the invention, the frame page includes a data frame configured to display data pages. The view pattern is configured to provide a template used during generation of a data page. The frame page includes user interface controls that need be loaded only once and remain in place on the frame page even though different data pages are opened. The frame page contains user interface controls selected from the group consisting of buttons, page sets, and nested data frames. Each user interface control has a state selected from the group consisting of enabled, disabled, selected, and mouseover. A data page includes user interface controls selected from the group consisting of SVG controls and dynamic GIF controls.

In other, more detailed features of the invention, a view is an implementation of the view pattern, and the non-visual components include a view descriptor, a CSS style sheet, and a Java Script file. The view descriptor is configured to control the visual components. The CSS style sheet is configured to provide a user with control of visual attributes of the visual components selected from the group consisting of color, font, size, position, and alignment. The Java Script file is configured to interpret the view descriptor and to initialize the frame page. The view descriptor is an extensible markup language configuration file.

In other, more detailed features of the invention, the CSS style sheet includes an application pattern CSS style sheet, a view pattern CSS style sheet, and a view CSS style sheet. The application pattern CSS style sheet contains styles that are general to the application pattern. The view pattern CSS style sheet contains styles that are specific to a type of view pattern. The view CSS style sheet contains styles that are specific to a view pattern.

In other, more detailed features of the invention, the Java Script file includes a common file, a control file, an application pattern manager file, a view pattern manager file, and a view manager file. The common file is configured to provide common functionality for the application pattern. The control file is configured to automate dynamic graphic user interface controls. The application pattern manager file is configured to provide common functionality used by the view pattern. The view pattern manager file is configured to provide specific functions required by the view pattern. The view manager file is configured to provide functions required by a specific view pattern.

Another exemplary embodiment of the invention is a system including a computer and an application server. The computer includes a computer-readable medium containing a web site development software program. The program includes an application pattern and a tag library. The application pattern includes a view pattern, wherein the application pattern includes style elements, presentation elements, and navigation logic elements, and the view pattern incorporates the style elements and presentation elements of the application pattern. The tag library includes tags and is configured to allow rendering graphic user interface components.

In other, more detailed features of the invention, the tags support dynamic graphic user interface controls. The application server includes an engine having a model, a direct controller, and Java Server Pages Rendering Components. A view is an implementation of the view pattern, and the tag library is configured to provide an interface link between the view and the model in the application server. The model is configured to interact with the direct controller to perform business logic processing.

Other features of the invention should become apparent from the following description of the preferred embodiments taken in conjunction with the accompanying drawings, which illustrate, by way of example, the principles of the invention.

### BRIEF DESCRIPTION OF THE DRAWINGS

FIG. 1 is a block diagram illustrating a view and an application server; and

FIG. 2 is a block diagram illustrating a preferred embodiment of a view pattern architecture according to the present invention.

### DETAILED DESCRIPTION OF THE PREFERRED EMBODIMENTS

The WEBACCEL™ software package (“the software package”) provided by Compuflex International, Inc. located in Woodland Hills, Calif. is an integrated package of components, development tools, and design patterns that supports rapid development of Internet and Intranet Web sites. The software package includes a complete development framework for building database-enabled Java server pages (“JSP”), and thus, a developer can rapidly set up the structure of an application without extensive coding normally required for such an application. Also, the designer can use sophisticated data-related components within JSP pages without any knowledge of Java or JSP development. Accordingly, a developer can reduce development time by up to 80% by using the software package. The software package is used to develop a true thin-client application since it requires only a standard browser on the user's workstation. As a result, applications can be deployed over the Internet, on an internal Intranet, or via a company Extranet. In addition to being used alone, the software package is fully extensible so the user can add their own server-based Java classes and design patterns to the development framework.

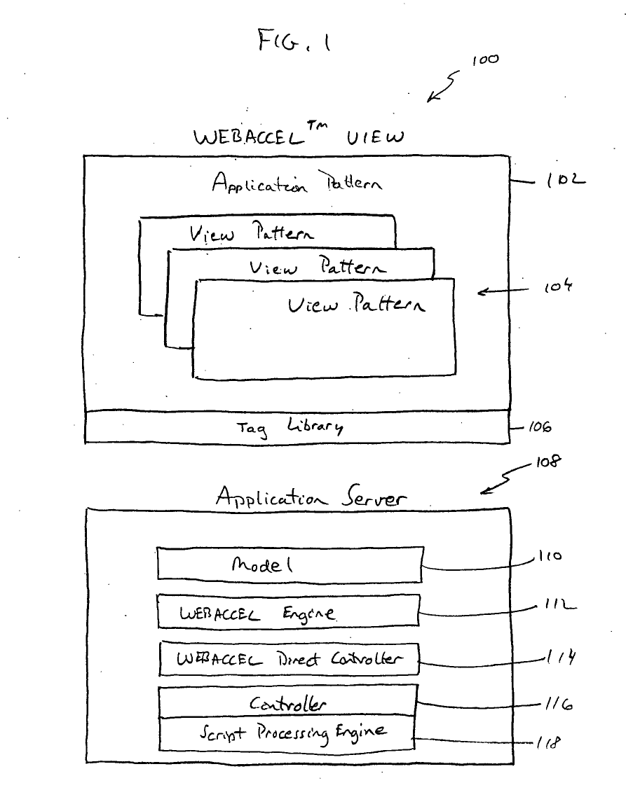

The main components of the software package's architecture are depicted in FIG. 1. As shown, the architecture components include: a view 100, which is an implementation of a view pattern 104. The view pattern is a part of an application pattern 102, and is, in part, constructed with a tag library 106. The architecture also includes an application server 108, which includes an engine 110 having a model 112, direct controller 114, and Java Server Pages rendering components 116.

The view 100 is a customized implementation of a view pattern 104, which is part of an application pattern 102. The view uses a tag library 106 for common GUI capabilities, e.g., for placing specific components onto the page and for interacting with application server 108 processing. The application pattern allows Web site developers to create powerful, standardized, thin-client user interfaces, which support the rapid development of complex business applications. Each application pattern supports a standardized “look and feel” for the application, including color scheme, user interface controls, and navigation. An application pattern includes one or more view patterns, which are standardized templates for specific types of user interface windows, supporting a specific type of common application functionality. An application is constructed from one or more views, each of which is an implementation of a specific view pattern. Each view therefore inherits all of the graphical user interface controls, presentation logic, behavior and “look and feel” of the application pattern and view pattern.

The application pattern 102 provides for the overall GUI structure elements of the application, including general style elements, presentation elements, and navigation logic elements, for example, menu systems, which allow the user to access various parts of the application pattern. In particular, the application pattern includes a login, error reporting, navigation system, master cascading style sheets (“CSS”) style sheet, and an application manager. The login is a standardized login user interface, which allows the user access to the application pattern once authenticated. Error reporting includes any default error reporting pages for reporting and handling errors. The navigation system is a standard navigation system which includes a main menu and any desired navigation components from within the application pattern. In most application patterns, it is desirable for all view patterns 104 to share common style elements, for example, background color, font family, and font color. These styles are defined in the master CSS style sheet which applies to all view patterns in the application pattern. The application manager is a master JavaScript file that contains common functionality used by all view patterns. Thus, the application pattern provides overall user interface guidelines for all view patterns.

Each view pattern 104 provides a unique set of user interface capabilities for a particular type of window. The view pattern inherits all style and presentation logic elements of the application pattern 102 and supports all standard user interface functionality. Normally, view patterns are developed by a framework development team and are used by developers when constructing views 100. Examples of view patterns include the following: an administration view pattern, which provides support for editing simple lookup table values; a search/list view pattern, which provides support for complex searches, lists the search results, and allows for editing of multiple related database tables; and a report view pattern, which allows for the selection of a report to run, the entry of report criteria values, and the running and viewing of the report. The developer adds business-specific components and functionality to an individual view, which is an implementation of a specific view pattern. For example, the developer could develop a general ledger view for maintaining general ledger information based on a search/list view pattern.

The tag library 106 provides the link between the view 100 and the model 112 in the application server 108. For example, tags included in the JSP pages support a standardized interface with components in the application server. Tags are also used to support dynamic GUI controls and other types of view layer support which are discussed later in this document.

The application is supported by an engine 110 running on a commercially-available application server 108. The engine contains the model 112, direct controller 114, and Java Server rendering components 116. The model is responsible for interacting with all back-end data sources (not shown) (such as a relational database), and for performing business logic processing. The model interacts with a direct controller to perform server-side business logic processing based on scripts submitted from the Web pages in the view layer. All server-based components comprise an engine for supporting and generating application pages which are sent to the browser using the hyper text transport protocol (“HTTP”), and are rendered in the browser.

View Pattern Components

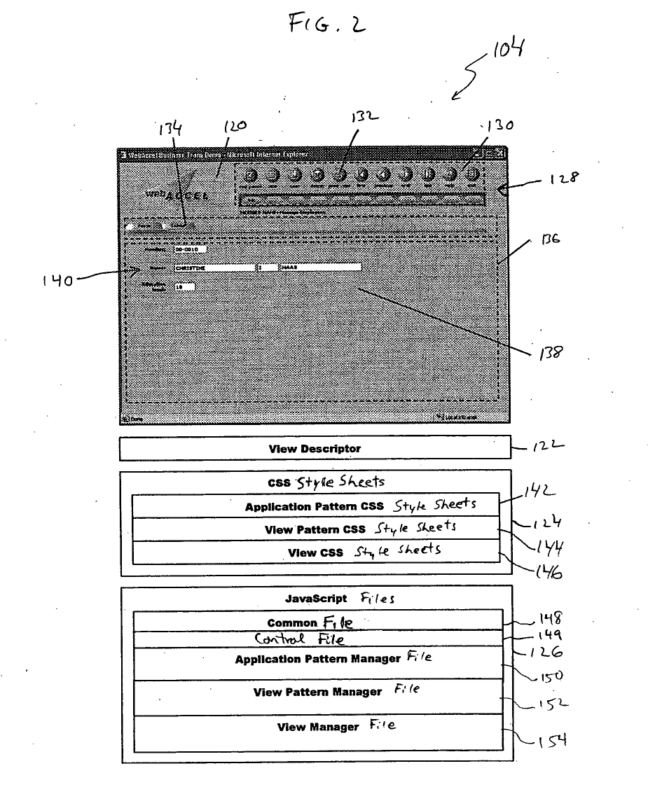

FIG. 2 depicts the components of a view pattern 104 according to the present invention for an example tab page view pattern. The view pattern includes a single main frame page 120, which contains all of the other components, both visual and non-visual, of the view pattern. The visual components of the view pattern are included in the frame page, while the non-visual components are included in the view descriptor 122, CSS style sheets 124, and JavaScript files 126.

The top section 128 of the frame page 120 is reserved for persistent controls, which remain as part of the frame page as long as it is open. The toolbar control 130 is located in the top section of the frame page and provides the user with common user interface functionality. The toolbar control can be developed using scalable vector graphics (“SVG”) or by dynamically positioning graphic image components, e.g., GIF or JPEG. Toolbar buttons 132 included in the toolbar control may be enabled, disabled, or hidden, and can be coupled with specific JavaScript functions. All user interface controls can be security controlled as well, e.g., disabled for a specific class of user if desired. Thus, each toolbar button has a set of security state definitions that allow the developer to protect access to elements based on user identity.

Another type of control is the tab page control 134, which also is located in the top section 128 of the frame page 120. The tab page control is loaded only once when the frame page opens, and provides any number of dynamic tabs. The frame page also contains a data frame 136, which is used to display interactive data pages 138 for the application. Each tab page references its own data page, which is loaded when the user selects the corresponding tab. For example, in FIG. 2, a single data frame is used and the content of the data frame changes as the user selects the various tab pages using the tab page control. Other view patterns 104 can include more than one data frame, and the data frames can be displayed in a synchronized manner.

Data pages 138 are used to display and retrieve business transaction information 140. After a view pattern 104 is developed and tested, data pages and their contents are the only visual elements that need to be created by the developer. Typically, a complete view pattern provides templates for the data pages, so they can be created rapidly, exactly matching the graphical standard established by the view pattern. Optionally, data pages may contain user interface controls of their own, for example, buttons, additional page sets, and nested data frames. Generally, the data page is under the complete control of the developer.

The view descriptor 122 is an extensible markup language (“XML”) configuration file, which contains initialization information for the specific implementation of a view pattern 104 and is invoked when the frame page 120 is loaded. More specifically, the frame page loads the view descriptor as part of its hidden page content. The view manager JavaScript files 126 (discussed below) provides functions to interpret the view descriptor, initialize the frame page, and perform other presentation logic functions. Java server page (“JSP”) tags also can be used to dynamically initialize various view pattern components based upon the content of the view descriptor. Dynamic tab page definitions are an example of content contained in the view descriptor. The CSS style sheets 124 allow for the consistent and centralized control of various attributes, for example, color, font, and size of the visual objects displayed by the user. The CSS style sheets include an application pattern CSS style sheet 142, view pattern CSS style sheets 144, and view CSS style sheets 146.

Each application pattern CSS style sheet 142 is another hidden file, which is loaded by the frame page 120. The application pattern CSS style sheet provides common HTML-style information used by the entire application pattern 102. The view pattern CSS style sheet 144 provides specific HTML-style information for a given type of window, which applies to the current view pattern 104. The view CSS style sheet 146 is an optional style sheet added by the developer that provides style settings to a specific view pattern. All data pages 138 referencing the specific view pattern will have the view CSS styles applied to them in addition to the application and view pattern styles. Thus, any styles included in the application pattern or view pattern CSS style sheets are overridden by the view style definitions included in the view CSS style sheets.

JavaScript files 126 provide all of the presentation logic and front-end processing for the view pattern 104. JavaScript is a highly-flexible language, however, it is difficult to debug. Therefore, the use of JavaScript generally is limited to presentation logic and the invocation of server-side processing. The use of JavaScript files, where each JavaScript file provides a specific layer of functionality, allows the development team to write less JavaScript code for each view pattern. This results in faster development with higher quality and reliability.

The view pattern's frame page 120 loads five separate JavaScript files: the common file 148, the control file 149, application pattern manager file 150, view pattern manager file 152, and an optional view manager file 154. The common file provides common functionality, for example, form field validation and formatting. The common file is usually the fwCommon.js file provided by the software package. The control file is configured to automate dynamic graphic user interface controls, including user security. The control file is usually the generic fwControls.js library file provided by the software package, which is used to automate dynamic GUI controls and widgets. The application pattern manager file provides common functionality used by all view patterns 104, for example, the control of navigation. The view pattern manager file provides the specific functions required for all implementations of a view pattern. An example of a view pattern manager file is the file associated with the processing of a click of a save button in the toolbar control 130. The view manager file includes any additional, extended, or customized JavaScript functions needed for a specific view implementation. An example of a view manager file may include a file for processing a custom option button.

### Application Pattern Component Locations and Naming

The software package is designed to support any number of application patterns 102, for example, a single company may want to use one application pattern for public Internet Web sites and another application pattern for an Intranet Web site. When a new application pattern is created, the developer must import the desired components into the application pattern. When using a plug-in for the Eclipse (the open source version of WebSphere Studio) the importation process is performed using the file-import-components menu. Also, a wizard included in the software package can be used to select an application pattern for importation. The importation of the application pattern automatically loads all components for each view pattern included in the application pattern.

A new directory ([WebAccelInstallRoot]/apppatters/[patternName]/ . . . ) is added to the software package's install structure to contain application patterns 102 that are available for import. Each unique application pattern, in addition to all standard directories are located under this new directory. For example, the application pattern and all of its view patterns 104 are located under the

[WebAccelInstallRoot]/apppatterns/[patternName]/webApplication directory. When the developer elects to import the components of an application pattern, all of the components contained within the application pattern directory are imported and update any older versions of such components. In particular, the following directories apply to application and view pattern components:

[WebAccelInstallRoot]/apppatterns/[patternName]/webApplication (“the webApplication sub-directory”),

[WebAccelInstallRoot]/apppatterns/[patternName]/webApplication/images (“the webApplication/images sub-directory”),

[WebAccelInstallRoot]/apppatterns/[patternName]/webApplication/template (“the webApplication/template sub-directory”),

[WebAccelInstallRoot]/apppatterns/[patternName]/webApplication/resources/css (“the webApplication/resources/css sub-directory”),

[WebAccelInstallRoot]/apppatterns/[patternName]/webApplication/resources/javascript (“the webApplication/resources/javascript sub-directory”),

[WebAccelInstalRoot]/apppatterns/[patternName]/webApplication/resources/svg (“the webApplication/resources/svg sub-directory”),

[WebAccelInstallRoot]/apppatterns/[patternName]/webApplication/resources/views (“the webApplication/resources/views sub-directory”), and

[WebAccelInstallRoot]/apppatterns/[patternName]/webApplication/resources/xslt (“the web sub-directory”). Each sub-directory contains a specific type of component as defined below, along with standard component naming conventions.

The webApplication sub-directory contains reusable pages for application and view patterns 102 and 104, respectively, and component pages, including the frame pages 120 and XML data files that are included in the application server 108. Application pattern pages are named according to the following convention:

ap[patternID][PageName].[jsp|html|xml], for example, apBTRLogin.jsp. View pattern pages are named according to the following convention: vp[patternID][PageName].[jsp|html|xml], for example, vpSLVFrame.jsp. Component pages can be of any desired naming convention including the following: vw[patternID][PageName].[jsp|html], for example, vwSLVCompanyForm.jsp.

The webApplication/template sub-directory contains pre-built template pages and files, which are used as a starting point by the developer when creating specific views, for example, a form entry template page used for creating data entry forms, for use in the application and view patterns 102 and 104, respectively. Template pages are named according to the following convention: vp[patternID][PageType]Template.[html|jsp|xml], for example, vpSLVEntryFormTemplate.jsp.

The webApplication/resources/css sub-directory includes CSS style sheets 124 that are used by the application and view patterns 102 and 104, respectively. The application pattern CSS style sheets 142 are named according to the following convention: ap[patternID].css, for example, apBTR.css. In contrast, the view pattern CSS style sheets 144 are named according to the following naming convention: vp[patternID].css, for example, vpSLV.css.

The webApplication/resources/javascript sub-directory contains the application pattern manager, view pattern manager, and view manager JavaScript files 150, 152, and 154, respectively. The application pattern manager files are named according to the following convention: ap[patternID].js, for example, apBTR.js. The view pattern manager files are named according to the following convention: vp[patternID].js, for example, vpSLV.sj. The view manager files are named according to the following convention: vw[viewName].js, for example, vwSLVCompany.js.

If the SVG control files are utilized in the application pattern 102, the SVG control files are contained in the webApplication/resources/svg sub-directory contains SVG control files. The SVG control files are linked to the application pattern, and are named according to the following convention: ap[patternID][SVGName].svg, for example, apBTRTabPage.svg.

The webApplication/resources/views sub-directory contains the view descriptor 122 for each view pattern 104 as defined by the developer. The view descriptors are named according to the following convention: vw[patternID][ViewName].xml, for example, vwSLVCompany.xml.

The webApplication/resources/views/template sub-directory contains view descriptor templates with one view descriptor template for each type of view pattern 104. The view descriptor templates are named according to the following convention: vw[patternID]Template.xml, for example, vwSLVTemplate.xml.

The webApplication/resources/xslt sub-directory contains extensible style language transformation (“XSLT”) transformation files, which can be used to support the functionality of the application and view patterns 102 and 104, respectively. An example XSLT transformation file is one that transforms a menu XML document into a menu HTML page. XSLT transformation files are named according to the following convention: ap[patternID][Name].xslt and vp[patternID][Name].xslt for application patterns and view patterns, respectively. An application or view pattern also can define other types of components, for example, data sets and modules, which are stored in the standard directories for these component types.

### Dynamic Controls Architecture

Dynamic controls are a standard set of user interface controls, for example, toolbar buttons 132 and tab pages controls 134, which are generated and modified to reflect the current state of the view pattern 104. A set of dynamic controls is defined as part of an application pattern and view pattern design. Typically, these dynamic controls are used within the view pattern frame page 120, and provide the user with a consistent means for controlling view pattern functionality. By placing the dynamic controls on the frame page, they only need to be loaded once, and they remain in place even though different data pages 138 are opened. Since common images can be reused for different view patterns, dynamic controls advantageously result in fewer image files. Also, dynamic controls are initialized based on the security access of the user, and can be hidden or disabled if the user does not have sufficient access right to use them. In addition, dynamic controls reflect the current state of a view pattern, and are enabled or disabled as appropriate to a set of circumstances.

There are several types of dynamic controls that can be used in a view pattern 104. Two of the types used in the software package are SVG controls and dynamic GIF controls. SVG controls are implemented using a highly-flexible method for user-side generation of dynamic controls with excellent graphics quality. Dynamic GIF controls are created from a relatively small set of standard static image files and text overlays. The state of the dynamic GIF controls is controlled by “image swapping” resulting from a combination of HTML and JavaScript technology. While the use of dynamic GIF controls is somewhat less flexible than using SVG controls, it does provide a more standard and widely-supported result, and therefore, is more commonly used.

Dynamic controls include the following components: a control group, control, and control components. The control group is a container object, usually an HTML<TABLE> element, which contains a set of controls. Example control groups include a Tab Page Group and a Toolbar Group, each of which contain individual controls that share an area of the frame page 120. Each individual control within a control group, for example, a save toolbar button, is typically an HTML<TD> or <SPAN> element, which contains the actual visual components of the control, for example, the image or text label. The control receives and processes all of the user events, for example a mouseover or onclick. Control components are the actual visual components that make up each control, for example, an image and a text label. The image is the graphical image, usually an HTML<IMG> element, which displays the visual image associated with the control. The text label is a dynamic label, which overlays or is placed near the control image, usually an HTML<SPAN> tag. The text label describes the action that occurs when the control is clicked or selected. Each view pattern 104 defines a specific set of available control groups and controls, which can be utilized within the view pattern, and these can be customized by the developer.

Primarily, dynamic controls are rendered and manipulated through a page load process and a state manipulation process. During the page load process, the <fw:controlgroup> JSP tag initializes the dynamic controls based on information in the view descriptor 122 and the security rights of the user. Regarding the state manipulation process, the state of a dynamic control is changed when the dynamic control is selected. For example, if no changes have been made by the user on the frame page 120, the save button included in the toolbar control 130 may be disabled. Also, the state of any control can be manipulated via JavaScript calls designed for this purpose.

The following four dynamic control states are supported by the software package: enabled, disabled, selected, and mouseover. The enabled state is the normal state of the dynamic control, which allows the dynamic control to be clicked or selected by the user to perform an action. In the disabled state, a user's click of the dynamic control has no effect. Often, the control image and/or text is “grayed-out” to signify that the dynamic control is in the disabled state. In the selected state, some dynamic controls initially indicate that they are selected, for example, the current tab page control 134, in which case, special modification to the control image and/or text label may be desirable. Regarding the mouseover state, when the user moves the mouse over a dynamic control, the control should be highlighted in some fashion, and thus, affect the visual appearance of the control image and/or text label.

The dynamic controls architecture utilizes CSS style sheets 124, fwControls.js JavaScript file, JavaScript managers, the view descriptor 122, an application pattern controls XSLT file, a view pattern controls XSLT file, a <fw:view> tag, and a <fw:controlgroup> tag. The CSS style sheets are used to control the style of the control components, for example, the font, position, and alignment. Typically, two CSS style sheets, the application pattern CSS style sheet 142, which contains all of the styles that are general to the entire application pattern 102, and the view pattern CSS style sheet 144, which contains styles that are specific to a view pattern 104, are used.

The fwControls.js JavaScript file is the controls manager JavaScript file, which supports all general user-side control functionality, for example, control group initialization and stage-change processing. The JavaScript control managers include additional JavaScript manager files at the application pattern 102 and view pattern 104 levels that support processing of control events.

The view descriptor 122, more specifically, the <fw:controlGroups> section of the view descriptor defines the control groups and controls to be utilized by the view 100. The view descriptor is used by the <fw:controlgroup> tag to dynamically generate controls. The view descriptor is also loaded into the view pattern frame page 120, and thus, provides information regarding the controls to the fwControls.js functions. A sample view descriptor, which defines a set of 3 tab page controls 134 in the tab page (“TPG”) view pattern is included in file shown in appendix A.

The application pattern controls XSLT file is a transformation style sheet that provides the base functionality for generating control groups and controls at run time. This transformation style sheet is named [viewPatternName]Controls.xsl. Only one such transformation style sheet is created for the entire application pattern 102, which is used by all view patterns 104. This transformation style sheet is imported into each of the view pattern style sheets 144, and thus, eliminates the need for redundant code in each view pattern XSLT file.

The view pattern controls XSLT file is a transformation style sheet that provides the definition of the control groups and controls supported by a view pattern 104. This transformation style sheet is named [viewPatternName]Controls.xsl and has the ability to transform the view descriptor <fw:controlGroups> section, and thus, generate the required HTML for a control group. It is used by the <fw:controlgroup> tag to generate the control groups at run time. This transformation style sheet also provides the control state definition attributes for each control, for example, enabled, disabled, selected, and mouseover.

The <fw:view> tag is used on the view pattern frame page 120 to define the application pattern 102 and view pattern 104. This tag automatically generates the HTML required to load the necessary components including the CSS style sheets 124, JavaScript files 126, and view descriptor 122. In particular, the application and view pattern CSS style sheets 142 and 144, respectively, are automatically loaded through the use of the HTML<STYLE> elements. The following JavaScript files are loaded using HTML<SCRIPT> elements: fwCommon.js, fwControls.js, [applicationPatternName].js, [viewPatternName].js, and [viewName].js. The view descriptor XML is included in the frame page flow and supports various view pattern JavaScript functionality.

The <fw:controlgroup> tag is used to place a control group into a frame page 120. This tag uses the controlGroupID attribute to access the control group definition in the associated view descriptor 122, and then, dynamically generates the desired controls in the desired control state, including filtering for user security. This tag accomplishes the dynamic control generation by transforming the information in the view descriptor with the view pattern controls XSLT file.

Application and view patterns 102 and 104, respectively, are advantageous for various reasons including the following. First, the developer is shielded from all redundant user interface coding tasks, for example, maintaining toolbar controls 130, tab pages, navigation, and general presentation logic, which are all provided by the view pattern. Second, user interfaces are easily standardized, with the application and view patterns controlling the “look and feel” through a set of reusable components. Third, by using application and view patterns, Web site development times are greatly reduced while reliability is increased since the majority, up to 80 percent, of all bugs occur in the view layer, which can be debugged in a central manner with the debug changes applied to all view pattern implementations. Fourth, developers are not overly restricted since they have access to all underlying components of the software package's infrastructure when needed. Overall, this combination of high-level functionality and low-level access gives developers unprecedented freedom and flexibility. Also, each of the components at the various levels has been designed to maximize reuse and consistency, while supporting the dynamic controls architecture in addition to the general view pattern concept. While many components are involved, the developer rarely needs to know the detail of these components after the view pattern has been developed.

The foregoing detailed description of the present invention is provided for purposes of illustration, and it is not intended to be exhaustive or to limit the invention to the particular embodiments disclosed. The embodiments may provide different capabilities and benefits, depending on the configuration used to implement the key features of the invention. Accordingly, the scope of the invention is defined only by the following claims.

### APPENDIX A

```
  <!-- View Descriptor.-->
<fw:view ID=“view” type=“tpg” viewName=“vwTPGEmployeeSample”
  appPatternName=“apBTR” viewPatternName=“vpTPG”
  title=“Manage Employees” windowTitle=“WebAccel BusTrans Demo - Manage
Employees”
  module=“modEmployeeSample”
  xmlns:fw=“http://www.compuflex.com/framework/2.0”>
  <!-- Define GUI control groups.-->
  <fw:controlGroups ID=“controlGroups”>
    <!-- Main toolbar -->
    <fw:controlGroup ID=“mainToolbarDef” objectID=“mainToolbar”
type=“toolbarBtnGroup”>
      <fw:control ID=“tbBtnMenuDef” type=“tbBtnMenuControl”
        objectID=“tbBtnMenu”
        onclick=“top.apMgr.showMenu( );”
        initState=“enabled”
        noAccessRoleState=“enabled”
        text=“Menu”
        title=“Menu”>
        <assetRole name=“ALL” accessState=“enabled”/>
      </fw:control>
      <fw:control ID=“tbBtnNewDef” type=“tbBtnNewControl”
        objectID=“tbBtnNew”
        onclick=“top.vpMgr.doTBBtnNewOnClick(this);”
        initState=“enabled”
        noAccessRoleState=“enabled”
        text=“New”
        title=“New”>
        <assetRole name=“ALL” accessState=“enabled”/>
      </fw:control>
      <fw:control ID=“tbBtnSaveDef” type=“tbBtnSaveControl”
        objectID=“tbBtnSave”
        onclick=“top.vpMgr.doTBBtnSaveOnClick(this);”
        initState=“enabled”
        noAccessRoleState=“enabled”
        text=“Save”
        title=“Save”>
        <assetRole name=“ALL” accessState=“enabled”/>
      </fw:control>
      <fw:control ID=“tbBtnDeleteDef” type=“tbBtnDeleteControl”
        objectID=“tbBtnDelete”
        onclick=“top.vpMgr.doTBBtnDeleteOnClick(this);”
        initState=“enabled”
        noAccessRoleState=“enabled”
        text=“Delete”
        title=“Delete”>
        <assetRole name=“ALL” accessState=“enabled”/>
      </fw:control>
      <fw:control ID=“tbBtnPrintDef” type=“tbBtnPrintControl”
        objectID=“tbBtnPrint”
        onclick=“top.vpMgr.doTBBtnPrintOnClick(this);”
        initState=“enabled”
        noAccessRoleState=“enabled”
        text=“Print”
        title=“Print”>
        <assetRole name=“ALL” accessState=“enabled”/>
      </fw:control>
      <fw:control ID=“tbBtnFirstDef” type=“tbBtnFirstControl”
        objectID=“tbBtnFirst”
        onclick=“top.vpMgr.doTBBtnFirstOnClick(this);”
        initState=“enabled”
        noAccessRoleState=“enabled”
        text=“First”
        title=“First”>
        <assetRole name=“ALL” accessState=“enabled”/>
      </fw:control>
      <fw:control ID=“tbBtnPriorDef” type=“tbBtnPriorControl”
        objectID=“tbBtnPrior”
        onclick=“top.vpMgr.doTBBtnPriorOnClick(this);”
        initState=“enabled”
        noAccessRoleState=“enabled”
        text=“Prior”
        title=“Prior”>
        <assetRole name=“ALL” accessState=“enabled”/>
      </fw:control>
      <fw:control ID=“tbBtnNextDef” type=“tbBtnNextControl”
        objectID=“tbBtnNext”
        onclick=“top.vpMgr.doTBBtnNextOnClick(this);”
        initState=“enabled”
        noAccessRoleState=“enabled”
        text=“Next”
        title=“Next”>
        <assetRole name=“ALL” accessState=“enabled”/>
      </fw:control>
      <fw:control ID=“tbBtnLastDef” type=“tbBtnLastControl”
        objectID=“tbBtnLast”
        onclick=“top.vpMgr.doTBBtnLastOnClick(this);”
        initState=“enabled”
        noAccessRoleState=“enabled”
        text=“Last”
        title=“Last”>
        <assetRole name=“ALL” accessState=“enabled”/>
      </fw:control>
      <fw:control ID=“tbBtnHelpDef” type=“tbBtnHelpControl”
        objectID=“tbBtnHelp”
        onclick=“top.apMgr.showHelp(‘notopic’);”
        initState=“enabled”
        noAccessRoleState=“enabled”
        text=“Help”
        title=“Help”>
        <assetRole name=“ALL” accessState=“enabled”/>
      </fw:control>
      <fw:control ID=“tbBtnExitDef” type=“tbBtnExitControl”
        objectID=“tbBtnExit”
        onclick=“top.apMgr.closeFrameWindow(top);”
        initState=“enabled”
        noAccessRoleState=“enabled”
        text=“Exit”
        title=“Exit”>
        <assetRole name=“ALL” accessState=“enabled”/>
      </fw:control>
    </fw:controlGroup>
  <!-- Option buttons toolbar -->
  <fw:controlGroup ID=“optionBtnDef” objectID=“optionBtnToolbar”
type=“optionBtnToolbarGroup”>
      <fw:control ID=“optionBtn01Def” type=“optionBtnControl”
        objectID=“optionBtn01”
        onclick=“top.doInfoOnClick(this);”
        initState=“enabled”
        noAccessRoleState=“enabled”
        text=“Info”
        title=“Info”>
        <assetRole name=“ALL” accessState=“enabled”/>
      </fw:control>
      <fw:control ID=“optionBtn02Def” type=“optionBtnControl”
        objectID=“optionBtn02”
        onclick=“”
        initState=“disabled”
        noAccessRoleState=“disabled”
        text=“”
        title=“”>
        <assetRole name=“ALL” accessState=“enabled”/>
      </fw:control>
      <fw:control ID=“optionBtn03Def” type=“optionBtnControl”
        objectID=“optionBtn03”
        onclick=“”
        initState=“disabled”
        noAccessRoleState=“disabled”
        text=“”
        title=“”>
        <assetRole name=“ALL” accessState=“enabled”/>
      </fw:control>
      <fw:control ID=“optionBtn04Def” type=“optionBtnControl”
        objectID=“optionBtn04”
        onclick=“”
        initState=“disabled”
        noAccessRoleState=“disabled”
        text=“”
        title=“”>
        <assetRole name=“ALL” accessState=“enabled”/>
      </fw:control>
      <fw:control ID=“optionBtn05Def” type=“optionBtnControl”
        objectID=“optionBtn05”
        onclick=“”
        initState=“disabled”
        noAccessRoleState=“disabled”
        text=“”
        title=“”>
        <assetRole name=“ALL” accessState=“enabled”/>
      </fw:control>
      <fw:control ID=“optionBtn06Def” type=“optionBtnControl”
        objectID=“optionBtn06”
        onclick=“”
        initState=“disabled”
        noAccessRoleState=“disabled”
        text=“”
        title=“”>
        <assetRole name=“ALL” accessState=“enabled”/>
      </fw:control>
      <fw:control ID=“optionBtn07Def” type=“optionBtnControl”
        objectID=“optionBtn07”
        onclick=“”
        initState=“disabled”
        noAccessRoleState=“disabled”
        text=“”
        title=“”>
        <assetRole name=“ALL” accessState=“enabled”/>
      </fw:control>
      <fw:control ID=“optionBtn08Def” type=“optionBtnControl”
        objectID=“optionBtn08”
        onclick=“”
        initState=“disabled”
        noAccessRoleState=“disabled”
        text=“”
        title=“”>
        <assetRole name=“ALL” accessState=“enabled”/>
      </fw:control>
      <fw:control ID=“optionBtn09Def” type=“optionBtnControl”
        objectID=“optionBtn09”
        onclick=“”
        initState=“disabled”
        noAccessRoleState=“disabled”
        text=“”
        title=“”>
        <assetRole name=“ALL” accessState=“enabled”/>
      </fw:control>
      <fw:control ID=“optionBtn10Def” type=“optionBtnControl”
        objectID=“optionBtn10”
        onclick=“”
        initState=“disabled”
        noAccessRoleState=“disabled”
        text=“”
        title=“”>
        <assetRole name=“ALL” accessState=“enabled”/>
      </fw:control>
      <fw:control ID=“optionBtn11Def” type=“optionBtnControl”
        objectID=“optionBtn11”
        onclick=“”
        initState=“disabled”
        noAccessRoleState=“disabled”
        text=“”
        title=“”>
        <assetRole name=“ALL” accessState=“enabled”/>
      </fw:control>
      </fw:controlGroup>
    <!--Main tabs -->
    <fw:controlGroup ID=“mainTabsDef” objectID=“mainTabs” type=“mainTabPageGroup”>
      <fw:control ID=“tabEmployeeFormDef” type=“tabControl”
        objectID=“tabEmployeeForm”
        onclick=“top.vpMgr.doMainTabOnClick(‘tabEmployeeForm’);”
        initState=“enabled”
        noAccessRoleState=“enabled”
        text=“Form”
        title=“Employee Form”>
        <assetRole name=“adminRole” accessState=“enabled”/>
        <assetRole name=“demoRole” accessState=“enabled”/>
      </fw:control>
      <fw:control ID=“tabEmployeeTableDef” type=“tabControl”
        objectID=“tabEmployeeTable”
        onclick=“top.vpMgr.doMainTabOnClick(‘tabEmployeeTable’);”
        initState=“enabled”
        noAccessRoleState=“enabled”
        text=“Table”
        title=“Employee Table”>
        <assetRole name=“adminRole” accessState=“enabled”/>
        <assetRole name=“demoRole” accessState=“enabled”/>
      </fw:control>
    </fw:controlGroup>
  </fw:controlGroups>
  <!-- Define the logo to show on the view.-->
  <fw:viewLogo ID=“viewLogo” src=“images/logoWAEmployee.jpg”
className=“posLogo”/>
  <!-- Tab pages defs -->
  <fw:tabPageDefs ID=“tabPageDefs”>
    <fw:tabPage ID=“tpgEmployeeForm” objectID=“tabEmployeeForm”
      dataSet=“dsEmployee” parentTab=“”
      src=“vwTPGEmployeeForm.jsp” tabText=“Form” type=“main” tabStyle=“formEdit”/>
    <fw:tabPage ID=“tpgEmployeePagingTableEdit” objectID=“tabEmployeeTable”
      dataSet=“dsEmployee” parentTab=“”
      src=“vwTPGEmployeePagingTableEdit.jsp” tabText=“Table” type=“main”
      tabStyle=“pagingTableEdit” rowsPerPage=“10”/>
  </fw:tabPageDefs>
  <!-- Define popup windows.-->
  <fw:popupWindows ID=“popupWindows”>
    <fw:popupWindow ID=“puManager” dataSet=“dsManagerPopup” size=“normal”
src=“puManager.jsp” title=“Find a Manager”>
      <fw:param ID=“argEmpNo” mainFormID=“dsEmployee-EMPNO” type=“query”/>
      <fw:param ID=“dsEmployeePopup-EMPNO” mainFormID=“dsEmployee-MGRNO”
type=“return”/>
      </fw:popup Window>
    </fw:popup Windows>
  </fw:view>
```

What is claimed is:

1. A computer-readable medium included in a computer, wherein the computer-readable medium contains a web site development software program, the program comprising:
an application pattern having a view pattern wherein the application pattern includes style elements, presentation elements, and navigation logic elements, and the view pattern incorporates the style elements and presentation elements of the application pattern; and
a tag library configured to allow rendering of graphic user interface components.

2. The program according to claim 1, wherein the view pattern includes a frame page having visual components and non-visual components.

3. The program according to claim 2, wherein the visual components include a toolbar.

4. The program according to claim 3, wherein the toolbar is developed using a technique selected from the group consisting of scalable vector graphics and dynamically positioning graphic image components.

5. The program according to claim 3, wherein the toolbar includes toolbar buttons and each of the toolbar buttons has a state selected from the group consisting of enabled, disabled, mouseover, and hidden.

6. The program according to claim 2, wherein the frame page includes a data frame configured to display data pages.

7. The program according to claim 6, wherein the view pattern is configured to provide a template used during generation of a data page.

8. The program according to claim 6, wherein the frame page includes user interface controls that need be loaded only once and remain in place on the frame page even though different data pages are opened.

9. The program according to claim 6, wherein the frame page contains user interface controls selected from the group consisting of buttons, page sets, and nested data frames.

10. The program according to claim 9, wherein each user interface control has a state selected from the group consisting of enabled, disabled, selected, and mouseover.

11. The program according to claim 6, wherein a data page includes user interface controls selected from the group consisting of SVG controls and dynamic GIF controls.

12. The program according to claim 2, wherein a view is an implementation of the view pattern, and the non-visual components include:
a view descriptor configured to control the visual components;
a CSS style sheet configured to provide for the control of visual attributes of the visual components selected from the group consisting of color, font, size, position, and alignment; and
a Java Script file configured to interpret the view descriptor and to initialize the frame page.

13. The program according to claim 12, wherein the view descriptor is an extensible markup language configuration file.

14. The program according to claim 12, wherein the CSS style sheet includes:
an application pattern CSS style sheet that contains styles that are general to the application pattern;
a view pattern CSS style sheet that contains styles that are specific to a type of view pattern; and
a view CSS style sheet that contains styles that are specific to a view.

15. The program according to claim 12, wherein the Java Script file includes:
a common file configured to provide common functionality for all applications;
a control file configured to automate dynamic graphic user interface controls;
an application pattern manager file configured to provide common functionality used by the application;
a view pattern manager file configured to provide specific functions required by the view pattern; and
a view manager file configured to provide functions required by a specific view.

16. A system comprising:
a computer including a computer-readable medium, wherein the computer-readable medium contains a web site development software program, the program including:
an application pattern having a view pattern wherein the application pattern includes style elements, presentation elements, and navigation logic elements, and the view pattern incorporates the style elements and presentation elements of the application pattern, and
a tag library including tags and configured to allow rendering of graphic user interface components; and
an application server.

17. The program according to claim 16, wherein the view pattern includes a frame page having visual components and non-visual components.

18. The program according to claim 17, wherein the visual components include a toolbar.

19. The program according to claim 17, wherein the frame page includes a data frame configured to display data pages.

20. The program according to claim 19, wherein the frame page includes user interface controls that need be loaded only once and remain in place on the frame page even though different data pages are opened.

21. The program according to claim 17, wherein a view is an implementation of the view pattern, and the non-visual components include:
a view descriptor configured to control the visual components;
a CSS style sheet configured to provide for the control of visual attributes of the visual components selected from the group consisting of color, font, size, position, and alignment; and
a Java Script file configured to interpret the view descriptor and to initialize the frame page.

22. The program according to claim 21, wherein the CSS style sheet includes:
an application pattern CSS style sheet that contains styles that are general to the application pattern;
a view pattern CSS style sheet that contains styles that are specific to a type of view pattern; and
a view CSS style sheet that contains styles that are specific to a view.

23. The system according to claim 16, wherein the tags support dynamic graphic user interface controls.

24. The system architecture according to claim 16, wherein the application server includes an engine having:
a model;
a direct controller; and
Java Server Pages Rendering Components.

25. The system according to claim 24, wherein a view is an implementation of the view pattern, and the tag library is configured to provide an interface link between the view and the model in the application server.

26. The system according to claim 24, wherein the model is configured to interact with the direct controller to perform business logic processing.
